(19) United States
(12) Patent Application Publication
(10) Pub. No.: US 2007/0019020 A1
(43) Pub. Date: Jan. 25, 2007

(54) Printing device and printing method

(75) Inventor: Yoichi Wakai, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/338,302

(22) Filed: Jan. 23, 2006

(30) Foreign Application Priority Data
Jan. 21, 2005 (JP) 2005-14034
Jan. 20, 2006 (JP) 2006-11855

(51) Int. Cl. B41J 2/205

(52) U.S. Cl. 347/15

(57) ABSTRACT

In response to insertion of a memory card with recorded image data into a memory card slot and setting of a writable medium on an external storage unit, the printing device of the invention backs up image data from the memory card to the writable medium set on the external storage unit. On completion of image data backup, the printing device prints an index sheet including backup images arranged as index images. The technique of the invention is preferably applied to the printing device having the backup function of backing up image data recorded in a memory card and enables easy management of recording media as backup destinations of image data.

### CLAIM OF PRIORITY

The present application claims the priority from Japanese application P2005-14034A filed on Jan. 21, 2005 and P2006-11855A filed on Jan. 20, 2006, the contents of which are hereby incorporated by reference into this application.

### BACKGROUND OF THE INVENTION

1. Field of the Invention

The present invention relates to a printing device that has a backup function of backing up image data read from a memory card onto another recording medium.

2. Description of the Related Art

Currently popular printing devices are capable of directly reading and printing image data recorded in a memory card without an independent personal computer. One proposed printing device uses an external storage unit connected via a USB interface or another suitable interface to back up image data read from a memory card onto another medium such as an MO or a CD-ROM (see, for example, JP-A-2003-266880).

When multiple recording media are used as backup destinations of image data, there may be confusion in identification of backup image data in each recording medium.

### SUMMARY

The object of the invention is thus to eliminate the drawbacks of the prior art and to enable easy management of recording media as backup destinations of image data backed up by a printing device.

In order to attain at least part of the above and the other related objects, a printing device according to an aspect of the invention comprises: an image reading module that reads image data recorded in a first recording medium detachably set in the printing device; a backup module that backs up the read image data as backup image data onto a second recording medium, which is different from the first recording medium; and an index printing module that prints an index sheet including images of the backup image data arranged thereon as index images.

The printing device backs up image data from the first recording medium onto the second recording medium and automatically prints the index sheet including images of the backup image data as index images. The simple reference to the index sheet enables the user to identify the backup image data backed up on the second recording medium. The simultaneous storage of the second recording medium with the index sheet in an identical casing enables accurate identification of the backup image data backed up on the second recording medium and facilitates management of the second recording medium. The first recording medium detachably set in the printing device may not be physically set in or removed from the printing device but may be read in a non-contact manner, typically wirelessly.

In one preferable application of the printing device of the invention, the index printing module prints the index sheet on completion of backup of each set of read image data by the backup module.

This arrangement prints an index sheet for every first recording medium as a backup source and thus enhances the convenience of index sheets.

In another preferable application of the printing device of the invention, the index printing module prints the index sheet including a predetermined number of images arranged thereon, every time the number of backup image data that has been backed up by the backup module but has not yet been printed on the index sheet reaches the predetermined number.

This application fixes the number of images printed on each index sheet and thus desirably prevents wasteful consumption of index sheets. The predetermined number may depend upon the number of printable images on each index sheet, for example, 40 or 80.

In still another preferable application of the printing device of the invention, the index printing module prints the index sheet including identifiers for identifying individual backup image data backed up on the second recording medium.

The simple reference of the index sheet enables the user to readily identify the backup image data backed up on the second recording medium.

The identifiers may include a medium identifier for identifying the second recording medium and an image identifier for identifying each backup image data backed up on the second recording medium.

One typical example of the medium identifier is a volume label allocated in advance to the second recording medium. One typical example of the image identifier is a file name of each backup image data or a combination of a file name or a folder name. The index printing module may form a composite identifier as a combination of the medium identifier and each image identifier and print composite identifiers in the vicinity of the respective images. The index printing module may alternatively print only image identifiers in the vicinity of the respective images and print the medium identifier at a different location on the index sheet. The identifier may be printed as a character string representing the file name or the volume label or may be printed in an encoded form, such as a barcode or a QR code.

In one preferable embodiment of the invention, the printing device further includes: an identifier input module that inputs each of the identifiers printed on the index sheet; an image data reading module that reads corresponding image data identified by the input identifier from the second recording medium; and an image printing module that prints an image represented by the corresponding image data.

The arrangement of this preferable embodiment facilitates printing of the user's desired image from the index sheet. The identifier input module may use a keyboard or some operation button to input the identifier expressed by a character string or may use a barcode reader or a QR code reader to input the identifier expressed by a barcode or a QR code.

In one preferable configuration of this embodiment of the invention, the second recording medium has a printable label. The printing device further has a representative image printing module that selects representative images under a predetermined condition among the backup image data backed up on the second recording medium and prints the selected representative images on the label of the second recording medium.

Part of images represented by the backup image data are printed on the label of the second recording medium. This arrangement enables the user to readily identify the backup image data backed up on the second recording medium. This is especially effective for a writable CD or DVD used as the second recording medium, since the label on the CD or DVD has a relatively large area.

One preferable procedure for additionally printing an extra representative image prints a specific mark at a preset position to enable specification of a printing position of each representative image on the label. The procedure refers to the printed specific mark on the label with the printed representative images and a vacant space and additionally prints an extra representative image in the vacant space on the label. This application enables additional printing of extra representative images after completion of printing some representative images. The conventionally used media such as CD-RW, DVD-RW, and DVD+R are recordable and allow additional recording. This technique is especially useful for such a recordable medium to additionally print a representative image of each session after completion of the session. The printing position of the specific mark may be used to locate the second recording medium set in the representative image printing module. The user may manually inform the printing device of the printing position of the specific mark. A scanner may be provided in the representative image printing module to scan the printing position of the specific mark. The representative image printing module may be used exclusively for printing the label on the second recording medium or may share an identical printing mechanism with the index printing module.

Another preferable procedure for additionally printing an extra representative image stores at least a printing position of each representative image printed on the label of the second recording medium, in relation to the second recording medium. The procedure specifies the vacant space for additionally printing the extra representative image, based on the preset printing position of the specific mark and the printing position of each representative image stored by the printed representative image storage module. The user can readily specify the vacant space on the label, based on the printing position of the specific mark and the printing positions of the representative images printed on the label.

In one preferable example of the printing device of the above configuration, the backup image data backed up on the second recording medium are be divided in multiple folders. The representative image printing module selects image data recorded at a head or at an end among image data recorded in each folder, as a representative image.

This arrangement facilitates selection of the representative images.

In another preferable example of the printing device of the above configuration, each backup image data backed up on the second recording medium has time information regarding a date and time related to the backup image data. The representative image printing module retrieves the backup image data backed up on the second recording medium to select the representative images as either of image data having an earliest or latest time stamp out of image data with an identical date stamp; and image data having an earliest date stamp or a latest date stamp out of image data with an identical year or month stamp.

This arrangement also facilitates selection of the representative images.

In one preferable structure of the printing device of the invention, the second recording medium is set on an external storage unit connected with the printing device. The backup module backs up the image data onto the second recording medium by means of the external storage unit.

Typical examples of the external storage unit connected with the printing device include a CD-R/RW drive, a DVD±R/RW/RAM drive, an MO drive, and a hard disk drive. The external storage unit is connected with the printing device by means of, for example, a USB interface, an IEEE1394 interface, a wired network interface, or a wireless network interface.

The technique of the invention is not restricted to the printing device having any of the applications and arrangements discussed above, but may be actualized by a printing method that uses the printing device to print an index sheet or by a computer program that is executed by the computer to print an index sheet. The computer program may be recorded in a recording medium, such as a flexible disk, a CD-ROM, a magneto-optical disk, or a memory card.

### BRIEF DESCRIPTION OF THE DRAWINGS

FIG. 1 schematically illustrates the general configuration of a printing device in one embodiment of the invention;

FIG. 2 shows the internal structure of the printing device;

FIG. 3 is a flowchart showing a backup process;

FIG. 4 is a flowchart showing a representative image printing process;

FIG. 5 is a flowchart showing an order printing process;

FIG. 6 is a flowchart showing a representative image printing process in a second embodiment of the invention;

FIG. 7 shows an example of printing on a label in the second embodiment; and

FIG. 8 shows setting of a medium for additional printing in the second embodiment.

### DESCRIPTION OF THE PREFERRED EMBODIMENTS

Some modes of carrying out the invention are described below as preferred embodiments in the following sequence with reference to the accompanied drawings:

A. General Configuration of Printing Device

B. Internal Structure of Printing Device

C. Backup Process

D. Process of Printing Representative Images on Label in First Embodiment

E. Order Printing Process with Index Sheet

F. Effects

G. Second Embodiment

H. Modification

A. General Configuration of Printing Device

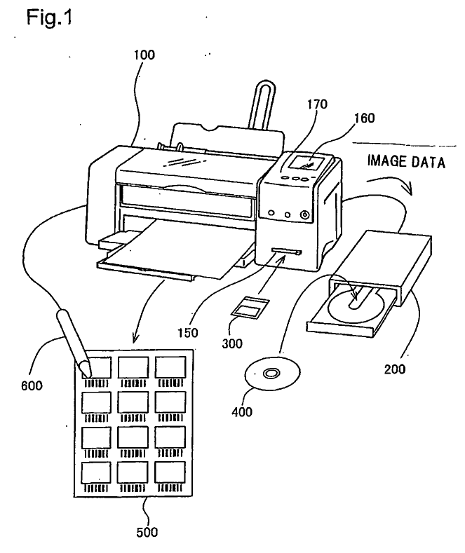

FIG. 1 schematically illustrates the general configuration of a printing device 100 in one embodiment of the invention. The printing device 100 of the embodiment includes a memory card slot 150 to receive a memory card 300 inserted therein, and is connected with an external storage unit 200 and with a barcode reader 600 via respective appropriate interfaces.

Typical examples of the memory card 300 inserted into the memory card slot 150 include CompactFlash (registered trademark), SD Memory Card (trademark), Memory Stick (trademark), and SmartMedia (trademark). The external storage unit 200 connected to the printing device 100 may be, for example, a CD-R/RW drive, an MO drive, a DVD-R/RW/RAM drive, or a hard disk drive.

The printing device 100 of this embodiment having the configuration discussed above has the backup function of backing up image data from the memory card 300 inserted in the memory card slot 150 onto a writable medium 400 set in the external storage unit 200.

The printing device 100 also has the function of printing an index sheet 500 including images arranged as indexes. These index images respectively correspond to the backup image data stored on the medium 400 set in the external storage unit 200. The user may keep the printed index sheet 500 together with the medium 400 having storage of the backup image data in one identical casing for effective and efficient image data management.

The index sheet 500 has a printed barcode in the vicinity of each index image as a unique identifier of the index image. When a barcode is scanned by the barcode reader 600, the printing device 100 reads image data identified by the scanned barcode from the medium 400 and prints an image represented by the identified image data. The user can thus readily print any desired image by referring to the index sheet 500.

B. Internal Structure of Printing Device

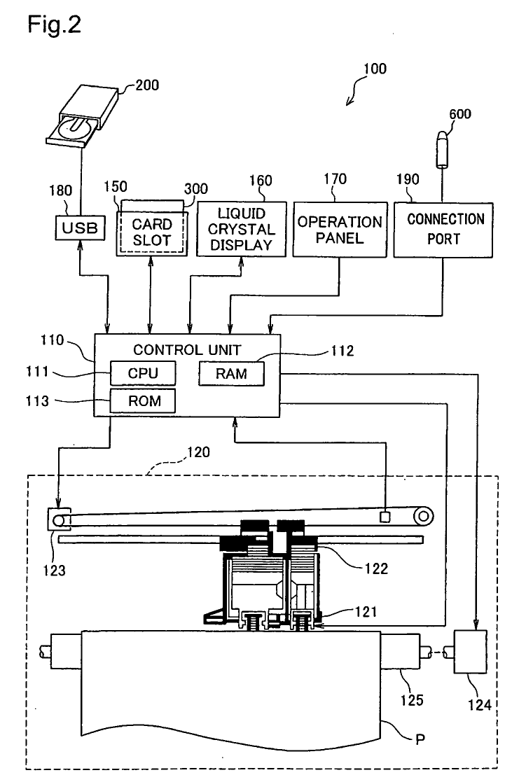

FIG. 2 schematically shows the internal structure of the printing device 100. As illustrated, the printing device 100 has a printing mechanism 120 for printing on printing paper P. The printing mechanism 120 includes a print head unit 121 that is mounted on a carriage 122 to eject inks on the printing paper P, a carriage motor 123 that is driven to move the carriage 122 in a main scanning direction, and a paper feed motor 124 that is driven to feed the printing paper P in a sub-scanning direction.

The printing device 100 also has a control unit 110 including a CPU 111, a RAM 112, and a ROM 113. The ROM 113 stores various programs, for example, a print program for controlling the printing mechanism 120 to print images, a backup program for backing up image data from the memory card 300 to the external storage unit 200, a representative image print program for printing selected representative images on a label of the medium 400, and an order print program for printing a specified image by the user's operation of the barcode reader 600. The CPU 111 reads these programs from the ROM 113 and executes the programs with the RAM 112 as a working memory.

As illustrated, the control unit 110 is connected to the printing mechanism 120, the memory card slot 150, a liquid crystal display 160 for display of operation windows, an operation panel 170 including multiple operation buttons, a USB port 180 for connection of the external storage unit 200, and a connection port 190 for connection of the barcode reader 600.

C. Backup Process

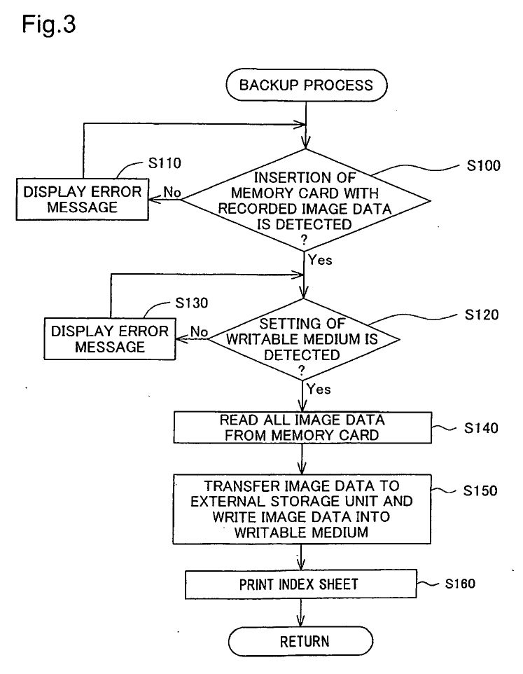

FIG. 3 is a flowchart showing a backup process executed by the CPU 111. The backup process backs up image data from the memory card 300 to the external storage unit 200. The CPU 111 starts the backup process in response to the user's operation of the operation panel 170 to select a backup option in a menu displayed on the liquid crystal display 160.

In the backup process, the CPU 111 first detects insertion of the memory card 300 with recorded image data in the memory card slot 150 (step S100). When no insertion of the memory card 300 is detected or when the inserted memory card 300 has no record of image data at step S100, the CPU 111 displays a preset error message like ‘Insert a memory card with recorded image data’ on the liquid crystal display 160 (step S110) and waits for insertion of the memory card 300 with recorded image data.

Upon detection of insertion of the memory card 300 with recorded image data in the memory card slot 150 at step S100, the CPU 111 subsequently detects setting of the writable medium 400 in the external storage unit 200 (step S120). When no setting of the medium 400 is detected or when the set medium 400 is unwritable at step S120, the CPU 111 displays a preset error message like ‘Set a writable medium’ on the liquid crystal display 160 (step S130) and waits for setting of the writable medium 400.

Upon detection of setting of the writable medium 400 in the external storage unit 200 at step S120, the CPU 111 reads all image data from the memory card 300 (step S140) and transfers the read image data to the external storage unit 200 and writes the image data into the writable medium 400 set in the external storage unit 200 (step S150).

According to a concrete procedure of step S150, the CPU 111 newly creates one folder having a folder name including a 3-digit serial number in a root directory of the medium 400 and records all the image data read from the memory card 300 into the newly created folder. For example, when a folder created in this cycle has a folder name ‘F001’, a subsequent folder created in a next cycle of the backup process has a folder name ‘F002’. Namely each cycle of the backup process creates one new folder having a different folder name and backs up read image data into the created new folder. The letter ‘F’ included in the folder name may be set arbitrarily by the user or may be set automatically by the CPU 111 according to a preset algorithm. The serial number has 3 digits in this embodiment. But this is only illustrative and the serial number may have a less number of digits or a greater number of digits.

When the medium 400 as a backup destination has no record of a volume label, the CPU 111 records a unique volume label in the medium 400 at step S150. The unique volume label may include the date and time of backup. This effectively prevents unintentional allocation of an identical volume label to multiple media.

The processing of steps S140 and S150 may be replaced by a modified process of collectively recording all the image data read from the memory card 300 into the RAM 112 and collectively transferring the image data from the RAM 112 to the external storage unit 200. Another modified process may read one image data at a time from the memory card 300 and transfer the read image data at each time to the external storage unit 200. The CPU 111 may read only image data having a preset extension, for example, ‘jpg’ or ‘gif’ at step S140. This arrangement effectively prevents unnecessary backup of non-image data.

On completion of transfer of the image data to the external storage unit 200 at step S150, the CPU 111 controls the printing mechanism 120 to print an index sheet 500 including images represented by the backup image data and arranged as indexes (step S160). In the illustrated example of FIG. 1, one printed index sheet 500 includes 3×4 index images. When the number of index images to be printed is greater than the number of index images printable on one index sheet, multiple index sheets are printed. The number of index images printable on one index sheet may be set arbitrarily by the user. The index sheet 500 preferably has a size receivable in the casing of the medium 400. The simultaneous storage of the index sheet 500 and the medium 400 in one identical casing facilitates the image data management. When the printing paper used for the index sheet 500 has a conventional size, for example, size A4, index images are desirably printed only in a preset area of the printing paper, which is smaller in size than the casing of the medium 400. The preset area may be defined by printing cutoff lines or fold lines. This facilitates size adjustment of the index sheet 500 to the size of the casing of the medium 400.

The CPU 111 also controls the printing mechanism 120 to additionally print a barcode below each index image as a unique identifier of the index image on the index sheet 500. The barcode is created by encoding three identifiers, that is, the file name and the folder name of the index image and the volume label of the medium 400 as the backup destination. The volume label of the medium 400 may be printed separately in the form of a character or letter string at a predetermined position on the index sheet 500. This latter arrangement enables the user to readily identify the medium 400 related to the index sheet 500. The barcode printed in this embodiment may be replaced by any other suitable code, for example, a QR code.

The backup process enables image data recorded in the memory card 300 to be readily backed up on a high-capacity medium, such as a CD-R without an independent personal computer. After the image data backup, the index sheet 500 is printed. The printed index sheet 500 enables the user to readily identify the medium 400 as the backup destination and the backup image data stored in the medium. In this embodiment, the CPU 111 starts the backup process in response to the user's selection of the backup option on the operation panel 170. The CPU 111 may automatically start the backup process in response to detection of insertion of the memory card 300 into the memory card slot 150.

D. Process of Printing Representative Images on Label in First Embodiment

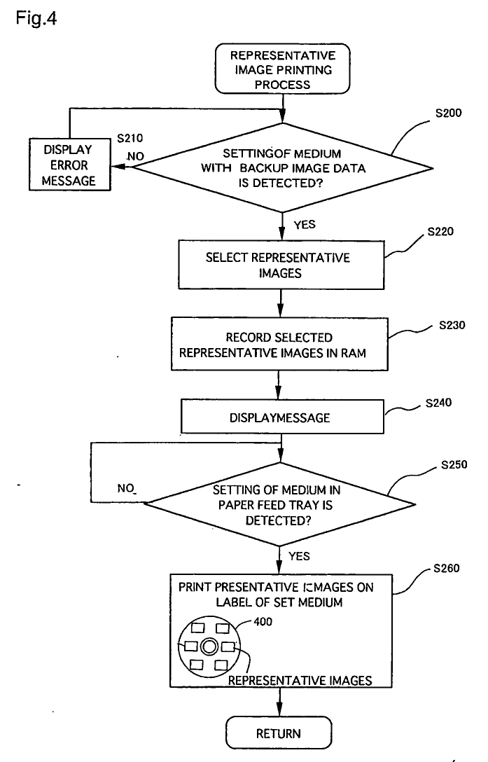

FIG. 4 is a flowchart showing a representative image printing process executed by the CPU 111. The representative image printing process prints representative images, which are representative of the backup image data stored in the medium 400, on the label of the medium 400. The CPU 111 starts the representative image printing process in response to the user's operation of the operation panel 170 to select a representative image printing option in the menu displayed on the liquid crystal display 160.

In the representative image printing process, the CPU 111 first detects setting of the medium 400 with backup image data in the external storage unit 200 (step S200). When no setting of the medium 400 is detected or when the set medium 400 has no storage of backup image data, the CPU 111 displays a preset error message like ‘Set a medium with backup image data’ on the liquid crystal display 160 (step S210) and waits for setting of the medium 400 with backup image data in the external storage unit 200.

Upon detection of setting of the medium 400 with backup image data in the external storage unit 200, the CPU 111 selects image data of representative images among the backup image data recorded in the medium 400 (step S220). According to a concrete procedure, the CPU 111 selects first image data recorded at a top of each folder in the medium 400 as a representative image. The CPU 111 then records the selected representative images in the RAM 112 (step S230). Another applicable technique of selecting representative images sorts out all the backup image data recorded in the medium 400 by the date and selects backup image data generated at the earliest time on each date or selects backup image data generated on the earliest date in each month or in each year as a representative image. The user may otherwise operate the operation panel 170 to select any arbitrary images among images displayed on the liquid crystal panel 160.

The CPU 111 then displays a preset message like ‘Take a medium out of the external storage unit and set the medium in the paper feed tray’ on the liquid crystal display 160 (step S240). According to this message, the user takes the medium 400 out of the external storage unit 200 and sets the medium 400 in a paper feed tray. When the medium 400 is not directly settable in the paper feed tray, a special tray that is exclusively used for media printing and includes the medium 400 is set in the paper feed tray. The CPU 111 may control the external storage unit 200 to automatically discharge the medium 400, simultaneously with the display of the message at step S240. The automatic discharge of the medium 400 further enhances the user's convenience.

In response to detection of setting of the medium 400 in the paper feed tray (step S250), the CPU 111 controls the printing mechanism 120 to print the representative images recorded in the RAM 112 on the label of the set medium 400 (step S260). In the illustrated example of FIG. 4, six representative images are printed on the label of the medium 400. When the number of the representative images recorded in the RAM 112 is greater than the number of representative images printable on the label of one medium, the representative images of only the printable number out of the selection are printed on the label of the medium. One modified procedure may read and store the volume label of the medium 400 at step S220 and print the volume label with the representative images on the label of the medium 400. The printed volume label facilitates identification of the medium 400 in a subsequent order printing process described later. When the number of the representative images recorded in the RAM 112 is greater than the number of representative images printable on the label of one medium, the user may select some of the representative images within the printable number on the label of one medium. When the number of the representative images recorded in the RAM 112 is smaller than the number of representative images printable on one medium, on the other hand, the smaller number of the representative images may be laid out concentrically at equal intervals of a fixed angle (for example, 2 representative images laid out at an interval of 180 degrees or 3 representative images laid out at intervals of 120 degrees). Another available technique specifies a maximum printable number Q (for example, six) of representative images on the label of each medium and fixes the printing positions of the respective representative images at intervals of 360/Q degrees. The printing positions of the representative images are sequentially determined clockwise (or counterclockwise) from an upper right end or an upper left end set as the angle ‘0’. The latter technique enables additional printing of extra representative images.

The representative image printing process prints representative images, which are representative of the backup image data recorded in the medium 400, on the label of the medium 400. This arrangement enables the user to readily identify the backup image data recorded in the medium 400. The representative image printing process of this embodiment directly prints the representative images on the label of the medium 400. The representative images may otherwise be printed on a label seal, which is attachable to a medium.

E. Order Printing Process with Index Sheet

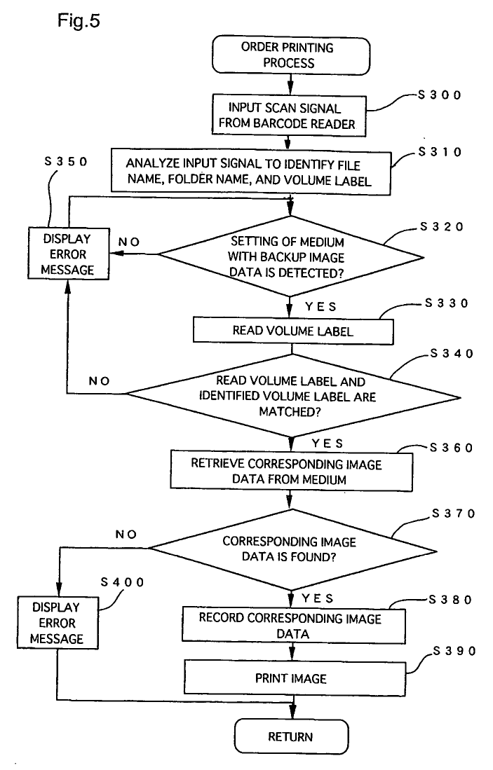

FIG. 5 is a flowchart showing an order printing process with the index sheet 500. The order printing process prints the user's desired images selected with the index sheet 500. The CPU 111 starts the order printing process in response to the user's operation of the operation panel 170 to select an order printing option in the menu displayed on the liquid crystal display 160.

In the order printing process, the CPU 111 first inputs a scan signal of each selected barcode among the barcodes printed on the index sheet 500 from the barcode reader 600 (step S300) and analyzes the input signal to identify the file name and the folder name of image data corresponding to the scanned barcode and the volume label of the backup medium 400 (step S310).

The CPU 111 then detects setting of the medium 400 with backup image data in the external storage unit 200 (step S320). Upon detection of setting of the medium 400 with backup image data in the external storage unit 200 (step S320: Yes), the CPU 111 reads the volume label from the set medium 400 (step S330) and compares the volume label read from the medium 400 with the volume label identified at step S310 (step S340). In response to match between the two volume labels (step S340: Yes), the order printing process goes to step S360 described below. In response to mismatch between the two volume labels (step S340: No) or upon no detection of setting of the medium 400 with backup image data in the external storage unit 200 (step S320: No), the CPU 111 displays a preset error message, which urges the user to set a right medium 400 with backup image data in the external storage unit 200 (step S350). In the event of mismatch between the two volume labels, the error message may include information on the volume label identified at step S310. The display of this error message enables the user to readily find out the right medium 400 by simple comparison with the volume label printed on the label of each medium 400.

The CPU 111 subsequently retrieves image data corresponding to the folder name and the file name identified at step S310 from the medium 400 set in the external storage unit 200 (step S360). When the result of the retrieval shows the presence of the corresponding image data (step S370: Yes), the CPU 111 records the retrieved image data in the RAM 112 (step S380) and controls the printing mechanism 120 to print an image represented by the recorded image data (step S390). When the result of the retrieval shows the absence of the corresponding image data (step S370: No), on the other hand, the CPU 111 displays a preset error message like ‘No corresponding image data is found’ (step S400) and terminates the order printing process.

According to the order printing process, the user readily obtains a print of any desired image selected among backup images by simply operating the barcode reader 600 to read a barcode allocated to the desired image on the index sheet 500.

F. Effects

As described above, the printing device 100 of the embodiment enables easy backup of image data from the memory card 300 to the medium 400 set in the external storage unit 200 without using an independent personal computer. After the image data backup, a list of backup images is printed on the index sheet 500. Simultaneous storage of the medium 400 and the corresponding index sheet 500 enables the user to readily identify each medium 400 and image data backed up on the medium 400.

The printing device 100 of the embodiment prints the representative images, which are selected among the backup image data recorded in the medium 400, on the label of the medium 400. This arrangement enables the user to readily identify the image data backed up on each medium 400.

The printing device 100 of the embodiment prints a unique barcode, which is allocated to each index image and includes the encoded volume label of the medium 400 and the encoded folder name and file name of the corresponding image data, in the vicinity of the index image on the index sheet 500. The user readily obtains a print of any desired image by simply operating the barcode reader 600 to read a corresponding barcode on the index sheet 500. The barcode includes information on the volume label of the medium 400 and thus ensures accurate identification of the medium 400 related to the index sheet 500. This arrangement effectively prevents printing of any unexpected images even when a wrong medium 400 is set in the external storage unit 200. The index images selected as the representative images may preferably be printed in a distinctive manner on the index sheet 500. The user can thus readily find out the representative images at any time.

G. Second Embodiment

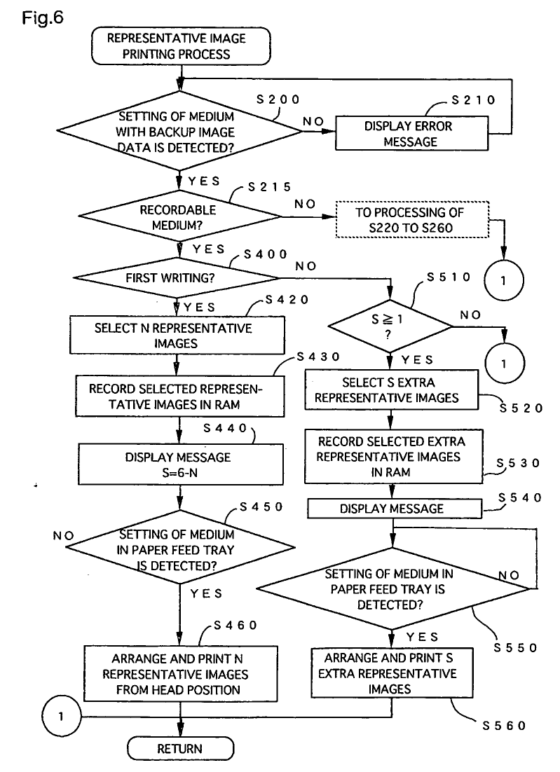

A printing device in a second embodiment of the invention has the identical hardware configuration with that of the printing device 100 of the first embodiment but executes a modified process of printing representative images on the label of the medium 400. The printing device 100 of the first embodiment does not especially take into account additional recording of image data into the medium 400. A recordable medium such as a CD+RW or a DVD+RW may be used as the medium 400 for image data backup. The printing device of the second embodiment executes a modified representative image printing process shown in the flowchart of FIG. 6, in place of the representative image printing process shown in the flowchart of FIG. 4. The identical processing steps in the representative image printing process of FIG. 6 with those in the representative image printing process of FIG. 4 are defined by the common step numbers and are not specifically described here.

In the representative image printing process of FIG. 6, the CPU 111 identifies whether the medium 400 is recordable (step S215) after detection of setting of the medium 400 in the external storage unit 200 (step S200). Examples of the recordable medium include multisession CD-ROM, DVD-R/W, DVD+R, and DVD+RW. While DVD-R/W is recordable by cancellation of the finalizing process, DVD+R and DVD+RW are recordable without the finalizing process.

In the case of the non-recordable medium 400, the representative image printing process executes the processing of and after step S220 shown in FIG. 4. In the case of the recordable medium 400, on the other hand, the CPU 111 specifies whether this is the first occasion of writing image data in the medium 400 (step S400). In the case of the first writing of image data in the medium 400, the CPU 111 selects N backup image data as representative images among the image data recorded in the medium 400 (step S420). The representative images selected here are first image data recorded at the heads of the respective folders in the medium 400 like the representative image printing process of the first embodiment. The selected representative images are then recorded in the RAM 112 (step S430). The selectable number N of representative images is restricted to 6 at the maximum for the clear layout of representative images on the label of the medium 400. Another suitable technique is applicable for selection of the representative images as described in the first embodiment. The user may otherwise operate the operation panel 170 to select any arbitrary images among images displayed on the liquid crystal panel 160.

The CPU 111 then displays a preset message like ‘Take a medium out of the external storage unit and set the medium in the paper feed tray’ on the liquid crystal display 160 and sets a reserved number of representative images for additional printing on the label of the medium 400 to a variable S (step S440). According to the message, the user takes the medium 400 out of the external storage unit 200 and sets the medium 400 in a paper feed tray. The CPU 111 lays out the N representative images selected at step S420 to be printed on the label of the medium 400 at intervals of 60 degrees and executes a printing process for printing the layout N representative images (step S460). The N representative images are laid out at intervals of 60 degrees starting from an upper end position (that is, a head position of printing) as a reference position. A symbol (‘Δ’ mark in this embodiment) indicating the reference position of printing is placed and printed at the upper end position.

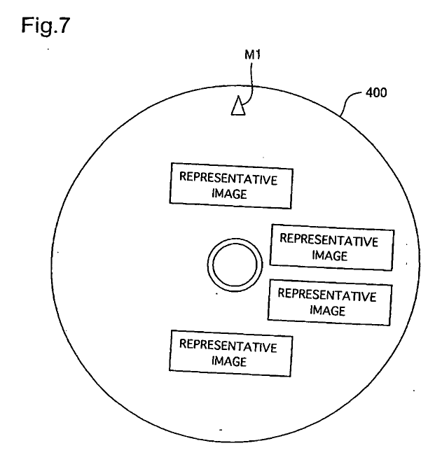

After the first printing on the label of the medium 400, the representative image printing process of FIG. 6 is terminated. FIG. 7 shows one example of a printed label on the medium 400 with N=4 at this moment. In the illustrated example of FIG. 7, a Δ mark M1 and four representative images laid out at intervals of 60 degrees starting from the Δ mark M1 are printed on the label of the medium 400. In this embodiment, the representative images themselves are not rotated in arrangement but are laid out at a fixed orientation. One modified procedure may lay out each representative image rotated about an image center by 60 degrees at every shift of the printing position by the angle of 60 degrees. The symbol indicating the reference position of printing is not restricted to the Δ mark but may be any of other various marks. The first representative image itself printed at the first printing position may be used as the symbol indicating the reference position.

In the case of non-first writing of image data in the medium 400 at step S400, on the other hand, when the value set to the variable S is not less than 1 at step S510, the CPU 111 selects S representative images among the images additionally written in the medium 400 (step S520). With regard to a multisession medium, the procedure selects S representative images from a last session. With regard to other media, the procedure manages the last backup date of the respective image data and retrieves additionally written image data based on the last backup date. The CPU 111 then records the selected S representative images in the RAM (step S530) and displays a preset message like ‘Take a medium out of the external storage unit and set the medium in the paper feed tray. Adjust the Δ mark on the label to the ∇ mark on the upper end of the paper feed tray’ on the liquid crystal display 160 (step S540).

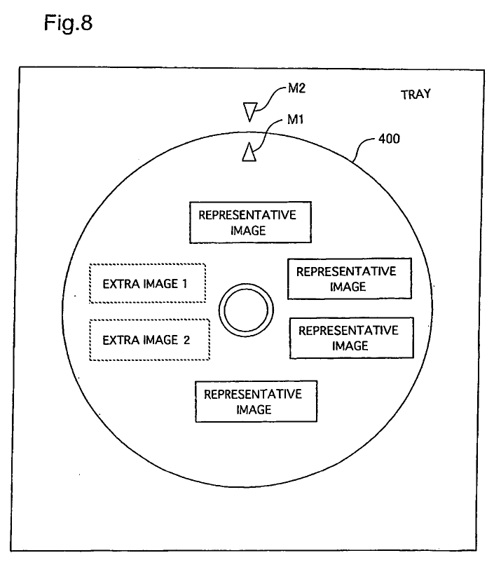

According to the message, the user sets the medium 400 at a specified position on a paper feed tray (step S550). FIG. 8 shows the medium 400 set at the specified position on the paper feed tray. Setting the medium 400 at the right position by adjustment of a Δ mark M1 on the label to a ∇ mark M2 on the tray enables extra representative images to be laid out in vacant spaces with no printed representative images. The CPU 111 controls the printing mechanism 120 to print the newly selected S representative images on the label of the medium 400 set on the paper feed tray (step S560) and terminates the representative image printing process of FIG. 6. In this embodiment, the number of representative images previously printed on the label of the medium 400 is entered manually on the operation panel 170 by the user. Another applicable technique may use a preset identifier allocated to each medium 400 for management of the number of representative images previously printed on the label of the medium 400. Specification of the number N of previously printed representative images automatically determines the number S of additionally printable representative images and their printable positions. The CPU 111 may thus control the printing mechanism 120 to print the number S of additionally printable representative images on the label of the medium 400. The representative image printing process of the second embodiment shown in the flowchart of FIG. 6 allows only one additional printing operation of extra representative images. Multiple additional printing operations may be allowed by setting a sufficiently large value to the maximum number N of printable representative images on the label of each medium. Another technique may restrict the number of representative images selected from each session to a small value, for example, 1 and allow representative images to be selected from a large number of different sessions.

As described above, the printing device of the second embodiment has the function of additional printing of extra representative images on the label of the medium 400, in addition to the effects of the first embodiment. This arrangement is especially effective for newly-developed recordable media but is also preferably applied to additionally print extra representative images on the label of any conventional medium, such as a CD-ROM, a CD-R, or a DVD-R. In the above embodiments, the number of representative images printable on one label is restricted to 6 at the maximum. This upper limit is, however, not restrictive but may be determined arbitrarily. One modified technique adjusts the size of each representative image according to the number of selected representative images and concentrically arranges and prints the size-adjusted representative images at equal intervals. In the case of a recordable medium, the procedure may arrange existing representative images and vacant spaces to allow additional printing of extra representative images in the vacant spaces. The number of vacant spaces to be arranged depends upon the rate of data recorded in the medium. For example, when there is an upper limit on the printable number of representative images, the number of representative images selected for first printing is determined according to the rate of the occupied storage capacity. When there is no upper limit on the printable number of representative images, the number of vacant spaces for additional printing of extra representative images is determined according to the number of representative images selected for first printing and the vacant storage capacity.

H. Modification

The embodiments discussed above are to be considered in all aspects as illustrative and not restrictive. There may be many modifications, changes, and alterations without departing from the scope or spirit of the main characteristics of the present invention. Some examples of possible modification are given below.

In the embodiment described above, the backup process prints an index sheet 500 after backup of all image data recorded in each memory card 300 onto a medium 400. Namely an index sheet is printed on every replacement of a memory card as a backup source. One modified procedure may arrange and print a predetermined number of unprinted images on an index sheet every time the number of backup image data of unprinted images reaches the predetermined number. When the number of backup image data backed up in one image data backup process does not reach the predetermined number, the procedure waits for printing an index sheet until a subsequent image data backup process. An index sheet is printed when the total number of backup image data including previously backed-up image data and newly backed-up image data reaches the predetermined number. This arrangement fixes the number of images printed on each index sheet and thereby prevents wasteful consumption of index sheets.

In this modified arrangement, each folder in the medium 400 may store only the predetermined number of backup image data and excess backup image data over the predetermined number may be stored in another folder. This desirably gives the consistency of images printed on one index sheet with backup image data included in one folder in the medium 400 as a backup destination.

In the embodiment described above, each barcode printed on the index sheet 500 includes information on the volume label, the file name, and the folder name. One possible modification provides a barcode representing only the volume label separately from a barcode representing the file name and the folder name. Only one barcode of the former type is printed at a preset position on the index sheet 500, whereas barcodes of the latter type are printed with individual images on the index sheet 500. The barcode reader 600 first reads the barcode representing the volume label to identify the medium and then reads the barcode representing the file name and the folder name to identify corresponding image data.

The backup process of the above embodiment backs up image data from the memory card 300 onto a medium set in the external storage unit 200. The backup process may back up image data from a digital camera, which is directly connected to the printing device by means of a USB interface, onto a medium set in the external storage unit 200.

In the configuration of the above embodiment, the external storage unit 200 is connected to the printing device 100 by means of the USB interface. The connection interface is, however, not restricted to the USB interface but may be any other suitable wired or wireless interface, for example, an IEEE1394 interface or a network interface. The external storage unit 200 may be built in the printing device 100.

In the embodiments described above, the printing device 100 executes the backup process and the order printing process. In another possible application of the invention, a general-purpose computer may be connected with a barcode reader, a printer, an external storage unit, and a monitor and execute the backup process and the order printing process.

What is claimed is:

1. A printing device, comprising:
an image reading module that reads image data recorded in a first recording medium detachably set in said printing device;
a backup module that backs up the read image data as backup image data onto a second recording medium, which is different from the first recording medium; and
an index printing module that prints an index sheet including images of the backup image data arranged thereon as index images.

2. A printing device in accordance with claim 1, wherein said index printing module prints the index sheet on completion of backup of each set of read image data by said backup module.

3. A printing device in accordance with claim 1, wherein said index printing module prints the index sheet including a predetermined number of images arranged thereon, every time the number of backup image data that has been backed up by said backup module but has not yet been printed on the index sheet reaches the predetermined number.

4. A printing device in accordance with claim 1, wherein said index printing module prints the index sheet including identifiers for identifying individual backup image data backed up on the second recording medium.

5. A printing device in accordance with claim 4, wherein the identifiers include a medium identifier for identifying the second recording medium and an image identifier for identifying each backup image data backed up on the second recording medium.

6. A printing device in accordance with claim 4, said printing device further comprising:
an identifier input module that inputs each of the identifiers printed on the index sheet;
an image data reading module that reads corresponding image data identified by the input identifier from the second recording medium; and
an image printing module that prints an image represented by the corresponding image data.

7. A printing device in accordance with claim 1, wherein the second recording medium has a printable label,
said printing device further comprising:
a representative image printing module that selects representative images under a predetermined condition among the backup image data backed up on the second recording medium and prints the selected representative images on the label of the second recording medium.

8. A printing device in accordance with claim 7, wherein said representative image printing module comprising:
a mark printing module that prints a specific mark at a preset position to enable specification of a printing position of each representative image on the label; and
an additional printing module that refers to the printed specific mark on the label with the printed representative images and a vacant space and additionally prints an extra representative image in the vacant space on the label.

9. A printing device in accordance with claim 8, wherein said additional printing module comprises:
a printed representative image storage module that stores at least a printing position of each representative image printed on the label of the second recording medium, in relation to the second recording medium; and
a vacant space specification module that specifies the vacant space for additionally printing the extra representative image, based on the preset printing position of the specific mark and the printing position of each representative image stored by said printed representative image storage module.

10. A printing device in accordance with claim 8, wherein the second recording medium is a data recordable medium, and
on completion of a session involved in additional recording of extra image data into the second recording medium, said additional printing module selects an extra representative image out of new backup image data newly backed up on the second recording medium and additionally prints the selected extra representative image on the label.

11. A printing deice in accordance with claim 7, wherein the backup image data backed up on the second recording medium are divided in multiple folders, and
said representative image printing module selects image data recorded at a head or at an end among image data recorded in each folder, as a representative image.

12. A printing device in accordance with claim 7, wherein each backup image data backed up on the second recording medium has time information regarding a date and time related to the backup image data, and
said representative image printing module retrieves the backup image data backed up on the second recording medium to select the representative images as either of:
image data having an earliest or latest time stamp out of image data with an identical date stamp; and
image data having an earliest date stamp or a latest date stamp out of image data with an identical year or month stamp.

13. A printing device in accordance with claim 1, wherein the second recording medium is set on an external storage unit connected with said printing device, and
said backup module backs up the image data onto the second recording medium by means of the external storage unit.

14. A printing method that uses a printing device to print an index sheet,
said printing method comprising the steps of:
reading image data recorded in a first recording medium detachably set in said printing device;
backing up the read image data as backup image data onto a second recording medium, which is different from the first recording medium; and
printing an index sheet including images of the backup image data arranged thereon as index images.

15. A program product that is loaded to and executed by a computer,
said program product comprising:
a medium that stores program codes recorded therein; and
the program codes that are recorded in the medium and are loaded by the computer to attain the functions of:
reading image data recorded in a first recording medium detachably set in said printing device;
backing up the read image data as backup image data onto a second recording medium, which is different from the first recording medium; and
printing an index sheet including images of the backup image data arranged thereon as index images.

16. A program product in accordance with claim 15, wherein the program codes are executed by the computer built in a printing device.

17. A computer readable recording medium that stores the program codes of a program product in accordance with claim 15.
